(19) United States
(12) Patent Application Publication
(10) Pub. No.: US 2010/0272850 A1
(43) Pub. Date: Oct. 28, 2010

(54) MOLD OF INJECTION MOLDING

(76) Inventor: Chien-Yin LEE, Taipei (TW)

Correspondence Address: Muncy, Geissler, Olds & Lowe, PLLC, 4000 Legato Road, Suite 310, FAIRFAX, VA, 22033, US

(21) Appl. No.: 12/768,070

(22) Filed: Apr. 27, 2010

(30) Foreign Application Priority Data
Apr. 28, 2009 (TW) 098114054

(51) Int. Cl. B29C 45/40

(52) U.S. Cl. 425/556

(57) ABSTRACT

A mold of injection molding for insert-molding an inserting element includes a first mold plate, a first mold core, a second mold plate, a second mold core, and a retreating device. The first mold core is assembled at one side of the first mold plate. The second mold core is assembled at one side of the second mold plate. The second mold core and the first mold core may form a mold cavity. The mold cavity has an oblique portion. The oblique portion and a parting direction of the first mold plate away from the second mold plate form an oblique angle. The retreating device has a movable block. The movable block faces the oblique portion and is movable along the direction vertical to the oblique portion. The movable block has a recess communicating with the mold cavity, and the inserting element is disposed at the recess.

### CROSS REFERENCE TO RELATED APPLICATIONS

This Non-provisional application claims priority under 35 U.S.C. §119(a) on Patent Application No(s). 098114054 filed in Taiwan, Republic of China on Apr. 28, 2009, the entire contents of which are hereby incorporated by reference.

### BACKGROUND OF THE INVENTION

1. Field of Invention

This invention relates to a mold and, more particularly, to a mold of injection molding.

2. Related Art

At present, casings of different kinds of consuming products are mostly formed by injection molding. During an injection molding process, molten molding materials are injected into a mold cavity of a mold. After the molding materials are cooled and hardened, the molding materials form the casing of the consuming product corresponding to the shape of the mold cavity.

FIG. 1 is a schematic diagram showing a conventional mold 1 of injection molding. The mold 1 has a male mold core 11 and a female mold core 12, and the male mold core 11 and the female mold core 12 form a mold cavity 13. The mold cavity 13 may have an oblique portion 131, and the oblique portion 131 may have a screw boss S for corresponding to a shape of a casing of a consuming product.

When the injection molding of the casing is finished and the mold 1 is parted, the male mold core 11 may move downward along a direction X. However, the oblique portion 131 is not vertical to the moving direction of the male mold core 11. When the mold 1 is parted, the portion of the casing at the oblique portion 131 is not easy to be ejected from the mold 1. In other words, after the casing is parted from the mold 1, the portion of the casing corresponding to the screw boss S of the oblique portion 131 may generate uneven flaws and reduce reliability of the product.

### SUMMARY OF THE INVENTION

This invention provides a mold of injection molding capable of allowing a casing with an oblique surface to be easily parted.

According to one aspect of the invention, the invention provides a mold of injection molding for insert-molding an inserting element. The mold includes a first mold plate, a first mold core, a second mold plate, a second mold core, and a retreating device. The first mold core is assembled at one side of the first mold plate. The second mold core is assembled at one side of the second mold plate. When the first mold plate approaches the second mold plate, the second mold core and the first mold core form a mold cavity. The mold cavity has an oblique portion. The oblique portion and a parting direction of the first mold plate moving away from the second mold plate form an oblique angle. The retreating device has a movable block. The movable block faces the oblique portion and is movable along a direction vertical to the oblique portion. The movable block has a recess communicating with the mold cavity, and the inserting element is disposed at the recess. After the inserting element is insert-molded and when the mold is parted, the first mold plate is away from the second mold plate, and the movable block moves along the direction vertical to the oblique portion to eject the inserting element from the recess.

In one embodiment of the invention, the retreating device may further have a linking element supporting the movable block.

In one embodiment of the invention, the retreating device may further have a driving unit connected with the linking element to allow the movable block to move along the direction vertical to the oblique portion.

In one embodiment of the invention, the mold cavity may further have a flat portion vertical to the parting direction of the first mold plate moving away from the second mold plate.

In one embodiment of the invention, the shape of the inserting element may correspond to that of the recess. The inserting element may be a screw boss or a hollow post.

According to the embodiment of the invention, the mold of the injection molding includes the retreating device. The movable block of the retreating device is movable along the direction vertical to the oblique portion of the mold cavity. The inserting element is disposed at the recess of the movable block. Therefore, When the inserting element is insert-molded and the mold is parted, the movable block can move along the direction vertical to the oblique portion thus to part the injected product to from the mold flatly by the movable block facing the oblique portion of the mold cavity. In addition, the inserting element, such as a screw boss, prevent the structure disposed at the oblique portion from having uneven thickness caused by the oblique surface thus to cause different hardening time of a molding material and defects of the product.

These and other features, aspects, and advantages of the present invention will become better understood with regard to the following description, appended claims, and accompanying drawings.

### BRIEF DESCRIPTION OF THE DRAWINGS

FIG. 1 is a sectional schematic diagram showing a conventional mold of injection molding;

FIG. 2 is a sectional schematic diagram showing a mold of injection molding according to one preferred embodiment of the invention; and

FIGS. 3A to 3C are schematic diagrams showing injection molding of a mold according to one preferred embodiment of the invention.

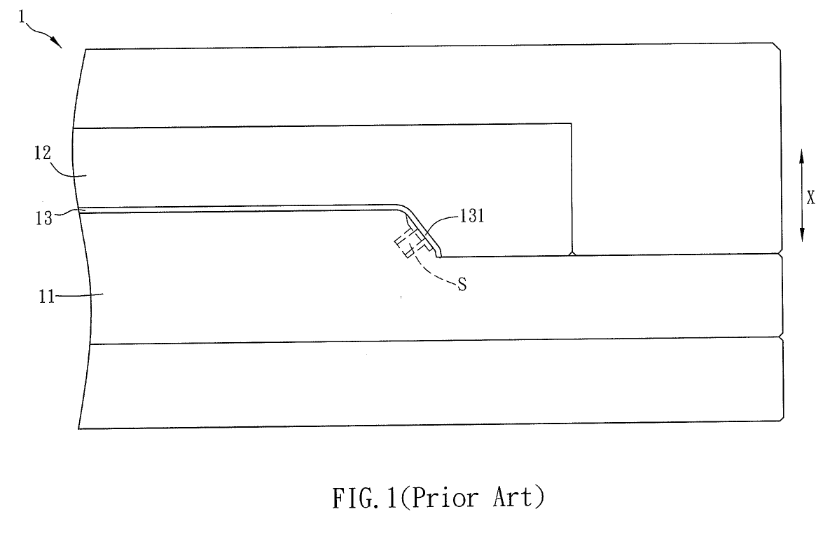

### DETAILED DESCRIPTION OF THE INVENTION

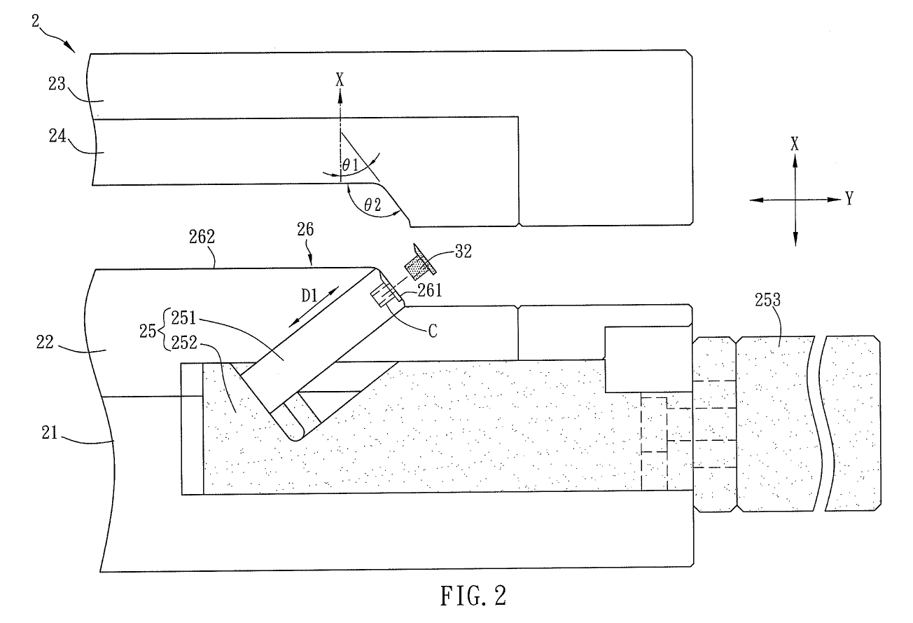

FIG. 2 is a sectional schematic diagram showing a mold 2 of injection molding according to one preferred embodiment of the invention. In FIG. 2, to clearly describe the mold 2, only part of the mold 2 is shown. In an actual application, the mold 2 should be a complete one. The mold 2 is used for insert-molding an inserting element 32. The mold 2 includes a first mold plate 21, a first mold core 22, a second mold plate 23, a second mold core 24, and a retreating device 25.

The first mold core 22 is assembled at one side of the first mold plate 21. The second mold core 24 is assembled at one side of the second mold plate 23. When the first mold plate 21 approaches the second mold plate 23, the second mold core 24 and the first mold core 22 form a mold cavity 26. The mold cavity 26 has an oblique portion 261. The oblique portion 261 and a parting direction X of the first mold plate 21 moving away from the second mold plate 23 form an oblique angle θ1. In addition, the mold cavity 26 can further have a flat portion 262 vertical to the parting direction X of the first mold plate 21 moving away from the second mold plate 23, and the flat portion 262 and the oblique portion 261 form an angle θ2.

The retreating device 25 has a movable block 251. The movable block 251 faces the oblique portion 261 and is movable along a direction D1 vertical to the oblique portion 261. The movable block 251 has a recess C communicating with the mold cavity 26. The inserting element 32 is disposed at the recess C, and the inserting element 32 directly faces the oblique portion 261. The shape of the inserting element 32 corresponds to that of the recess C. The inserting element 32 may be a screw boss, a protrudent post, or a hollow post. Therefore, the inserting element 32 prevents the structure disposed at the oblique portion 261 from having uneven thickness caused by the oblique surface to cause different hardening time of molding materials 31, further to cause the injected product to have uneven flaws.

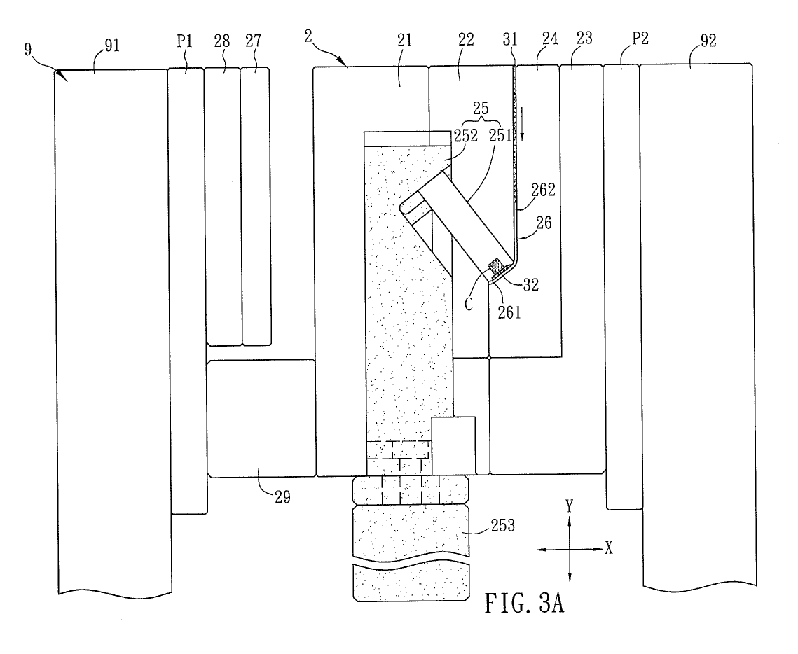

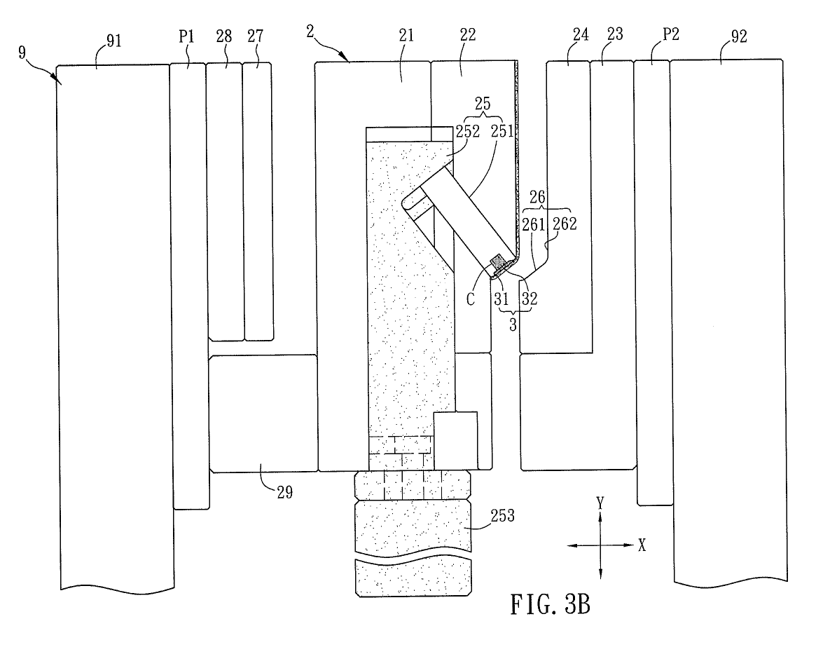

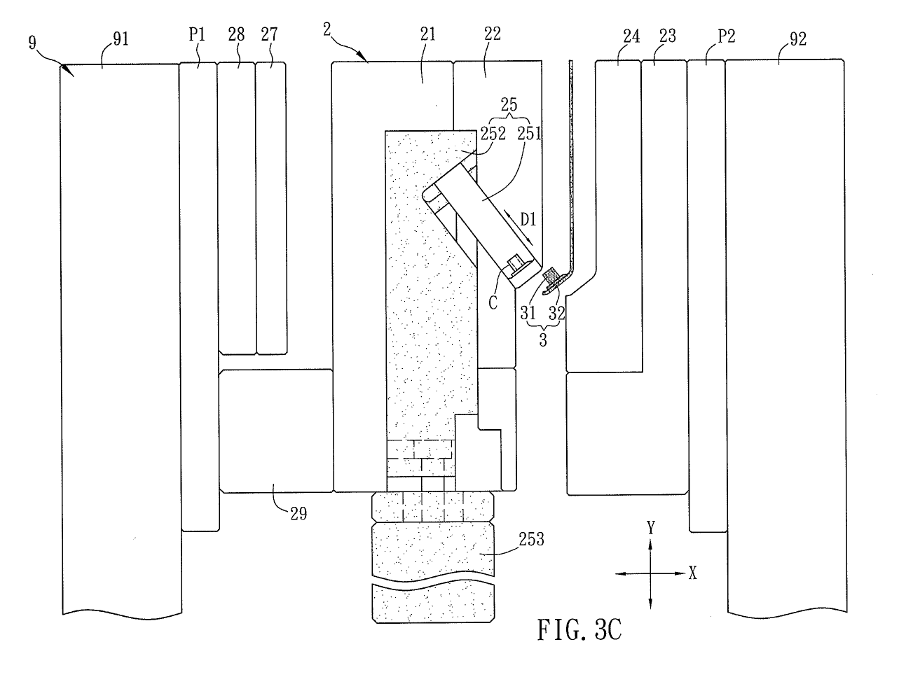

In addition, a molding material 31 (as shown in FIG. 3A) and the material of the inserting element 32 may be the same or different. If the two materials are different, the prior consideration is that the two materials will be tightly combined.

In the embodiment, the retreating device 25 can further have a linking element 252 and a driving unit 253. The linking element 252 supports the movable block 251, and the driving unit 253 is connected with the linking element 252 to allow the movable block 251 to move along the direction D1 vertical to the oblique portion 261. The linking element 252 may be a linking rod, and the driving unit 253 may be a motor, a cylinder, an oil cylinder, or an electric cylinder. Therefore, the driving unit 253 may drive the linking element 252 to reciprocate along a direction Y, further to drive the movable block 251 connected with the linking element 252 to reciprocate along the direction D1.

The movable block 251 may be integrally formed with the linking element 252 to be a single element. Otherwise, the movable block 251 is directly connected with the oblique driving unit 253, that is, the driving unit 253 may be disposed to be parallel to the moving direction D1 of the movable block 251. In the embodiment, the design of the retreating device 25 is just an example, as far as the movable block 251 may reciprocate along the moving direction D1.

FIGS. 3A to 3C are schematic diagrams showing injection molding modes of the mold 2 in the embodiment of the invention. In FIGS. 3A to 3C, to clearly describe the mold 2, only part of the mold 2 is shown. In an actual application, the mold 2 should be a complete one. In the embodiment, the mold 2 can cooperate with an injection machine 9. The mold 2 can further include a front ejecting plate 27, a back ejecting plate 28, and a mold block 29. The first mold plate 21, the first mold core 22, the front ejecting plate 27, the back ejecting plate 28, and the mold block 29 are fastened to a movable side 91 of the injection machine 9 via a clamping plate P1. The second mold plate 23 and the second mold core 24 are fastened to a fastened side 92 of the injection machine 9 by a clamping plate P2.

In FIG. 3A, after the inserting element 32 is first disposed at the recess C, the movable side 91 of the injection machine 9 can drive the first mold core 22 and the second mold core 24 to form the mold cavity 26. Then a molding material 31 may be injected into the mold cavity 26. After the mold cavity 26 is filled with the molding material 31, the molding material 31 may be connected with the inserting element 32. After the molding material 31 is cooled and hardened, the mold 2 may be parted.

In FIG. 3B, after the inserting element 32 is insert-molded, an injected product 3 is parted from the mold 2. First, the movable side 91 of the injection machine 9 may drive the first mold plate 21 and the first mold core 22 to move left along a direction X in FIG. 3B to be away from the second mold plate 23 and the second mold core 24. Then, in FIG. 3C, the driving unit 253 drives the linking element 252 to move upward along a direction Y in FIG. 3C, and the driving unit 253 can drive the movable block 251 connected with the linking element 252 to move upward and leftward together along a direction D1 vertical to the oblique portion 261 thus to eject the inserting element 32 from the recess C. Finally, the front ejecting plate 27 and the back ejecting plate 28 can eject the injected product 3 to complete the mold parting action. Therefore, the injected product 3 is flatly parted from the mold by the movable block 251 which is movable along the direction D1 vertical to the oblique portion 261.

According to the embodiment of the invention, the mold of the injection molding includes the retreating device. The movable block of the retreating device is movable along the direction vertical to the oblique portion of the mold cavity. The inserting element is disposed at the recess of the movable block. Therefore, When the inserting element is insert-molded and the mold is parted, the movable block moves along the direction vertical to the oblique portion thus to part the injected product to from the mold flatly by the movable block facing the oblique portion of the mold cavity.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A mold of injection molding for insert-molding an inserting element, comprising:
a first mold plate;
a first mold core assembled at one side of the first mold plate;
a second mold plate;
a second mold core assembled at one side of the second mold plate, when the first mold plate approaching the second mold plate, the second mold core and the first mold core forming a mold cavity, the mold cavity having an oblique portion, the oblique portion and a parting direction of the first mold plate moving away from the second mold plate forming an oblique angle; and
a retreating device having a movable block, the movable block facing the oblique portion and being movable along a direction vertical to the oblique portion, the movable block having a recess communicating with the mold cavity, the inserting element being disposed at the recess,
wherein when the inserting element is insert-molded and the mold is parted, the first mold plate away from the second mold plate, and the movable block moves along the direction vertical to the oblique portion to eject the inserting element from the recess.

2. The mold according to claim 1, wherein the retreating device has a linking element supporting the movable block.

3. The mold according to claim 2, wherein the retreating device has a driving unit connected with the linking element to allow the movable block to move along the direction vertical to the oblique portion.

4. The mold according to claim 3, wherein the driving unit has a motor, a cylinder, an oil cylinder, or an electric cylinder.

5. The mold according to claim 1, wherein the mold cavity has a flat portion vertical to the parting direction of the first mold plate away from the second mold plate.

6. The mold according to claim 1, wherein the shape of the inserting element corresponds to the shape of the recess.

7. The mold according to claim 1, wherein the inserting element is a hollow post.

8. The mold according to claim 1, wherein the inserting element is a screw boss.
